(19) United States
(12) Patent Application Publication
(10) Pub. No.: US 2024/0238883 A1
(43) Pub. Date: Jul. 18, 2024

(54) ELECTRIC POWER CIRCULAR SAW PLATFORM FRAMER

(71) Applicant: Michael George Suddes, Fernandina Beach, FL (US)

(72) Inventor: Michael George Suddes, Fernandina Beach, FL (US)

(21) Appl. No.: 18/098,408

(22) Filed: Jan. 18, 2023

(51) Int. Cl. B23D 45/02; B23D 47/02; B23D 47/04

(52) U.S. Cl. CPC B23D 45/024; B23D 47/02; B23D 47/04

(57) ABSTRACT

A platform apparatus for cutting an article of finished lumber or other building material comprises a platform supporting a power circular saw. The platform is fitted onto a stationary slide to slide back and forth on. The slide is fitted with a fence to push against a building material and also includes a saw blade slot through which the circular saw blade extends. Wherein the platform together with the stationary slide positions the circular saw blade to slide back and forth making precise cuts into the building material.

### CROSS REFERENCE TO RELATED APPLICATIONS

This application claims benefit of U.S. Provisional Application 63/324,604 filed Mar. 28, 2022, which is incorporated herein in its entirety.

### FIELD OF INVENTION

The present invention relates to the field of electric power circular saw platform framers and guides, and, more particularly to a platform guide apparatus for making 90° or angled cuts in various sizes (e.g., 2×4, 2×6, 4×6, etc) of lumber, decking, flooring, and rafters. Thickness of up to 1½ inches is most typical of flooring, decking, and trim.

### BACKGROUND

Wooden framing used in most wood-framed construction in the United States consist predominantly of 2×4 and 2×6 lumber. Constructing a building or other structure requires many different lengths of cut 2×4 and 2×6 lumber to precise lengths and at desired angles.

Making these precise cuts with an electric power circular saw can be very time consuming and prone to mistakes. An apparatus that can be attached to electric or battery-powered circular saw to simply and easily guide the saw blade to accurately and reliably cut lengths of 2×4 or 2×6 to speed construction and minimize mistakes that can result in a length of lumber that must be disposed.

Based on the foregoing, there is a need in the field for a framing device that can be attached to a circular saw and accurately guide the saw blade to make safe, consistent, and accurate 90° cuts.

### SUMMARY

In an embodiment, a platform apparatus for cutting 90° across an article of finished lumber comprises a platform supporting a power circular saw. The platform fitted onto a stationary slide to slide back and forth on. The slide fitted with a fixed fence to push against a lumber structure and a saw blade slot through which the circular saw blade fits. Wherein the platform together with the stationary slide positions the circular saw blade to make 90° cuts into the lumber structure.

In an embodiment, a cutting support device for a power circular saw comprises a platform framer including a sliding platform configured to secure to a power circular saw. A fixed stationary slide that slides into the sliding platform to support moving the sliding platform forward and across an article of lumber or other building material to make a 90° cut. The stationary slide including a saw blade slot for the power circular saw blade to extend through and an attached fence to position the stationary slide securely against the article of lumber.

In an embodiment, a platform apparatus for cutting across an article of building material comprises a platform supporting a power circular saw, with said platform adjustable for width. The platform is fitted onto a stationary slide to slide back and forth on and the slide is fitted with a folding fence to fold down and push against the building material, and there is a saw blade slot in the platform through which a power circular saw blade extends. Wherein the platform together with the stationary slide positions the power circular saw blade to saw through the building material.

In an embodiment, a cutting support device for a power circular saw comprises a fixed stationary slide that can fit against an article of building material comprised of a folding fence that folds downward to press against the article of building material and facilitate accurately positioning a power circular saw to make a desired cut. A sliding platform is configured to receive and secure a power circular saw onto the platform. The sliding platform fits on top of and mates to the stationary slide and is configured to slide back and forth along the stationary slide and across the article. The sliding platform includes a saw blade slot for the power circular saw blade to extend through and an adjustable sight gage to accurately visually position the power circular saw for the desired cut.

In an embodiment, a method for cutting an article of building material comprises supporting a power circular saw using a sliding platform, with said sliding platform adjustable for width. Fitting the sliding platform onto a stationary slide with sliding platform configured to slide back and forth on. Incorporating a folding fence into the sliding platform that can be folded down to push against the building material. Providing a saw blade slot in the sliding platform through which a power circular saw blade extends. Wherein the sliding platform together with the stationary slide positions the power circular saw blade to saw through the building material.

### Advantages:

1. Improved accuracy in cutting lumber for construction.
2. Improved safety by securing a saw to a work surface.
3. Ease in configuring an electric power circular saw into a light and easily utilized design.
4. Improved stability of circular saw in making precise cuts.
5. Cheaper and easier to implement; no metal components required.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an exemplary top view of a platform framer apparatus, according to an embodiment of the present inventions;

FIG. 2 is an exemplary side view of the longitudinal side of platform framer of FIG. 1, according to an embodiment of the present inventions;

FIG. 3 is an exemplary side view of the lower end side of platform framer of FIG. 1, according to an embodiment of the present inventions;

FIG. 3A is an exemplary enlarged view of saw hold down clamps 335 in FIG. 3, according to an embodiment of the present inventions;

FIG. 4 is an exemplary perspective top view of the platform framer apparatus, according to an embodiment of the present inventions;

FIG. 5 is an exemplary perspective bottom view of the platform framer apparatus, according to an embodiment of the present inventions;

FIG. 6 is an exemplary bottom view of the platform framer apparatus, according to an embodiment of the present inventions;

FIG. 7 is an exemplary side view of the upper end of the platform framer of FIG. 1, according to an embodiment of the present inventions;

FIG. 8 is an exemplary perspective top view of the platform framer, according to an embodiment of the present inventions;

FIG. 9 is an exemplary perspective bottom view of the platform framer, according to an embodiment of the present inventions;

FIG. 10 is another exemplary perspective bottom view of the platform framer of FIG. 9 with fence 985 in the down and closed position, according to an embodiment of the present inventions;

FIG. 11 is another exemplary perspective bottom view of the platform framer of FIG. 9 with fence 985 in the down and extended position, according to an embodiment of the present inventions;

FIG. 12 is an exemplary perspective top view of the platform framer with a stylized power circular saw attached, according to an embodiment of the present inventions;

FIG. 13 is an exemplary perspective top view of the platform framer with slide extended and the fence lowered and the platform framer fully opened, according to an embodiment of the present inventions; and

FIG. 14 is an exemplary top view of the platform framer fully opened and extended, according to an embodiment of the present inventions.

### DETAILED DESCRIPTION OF PREFERRED EMBODIMENTS

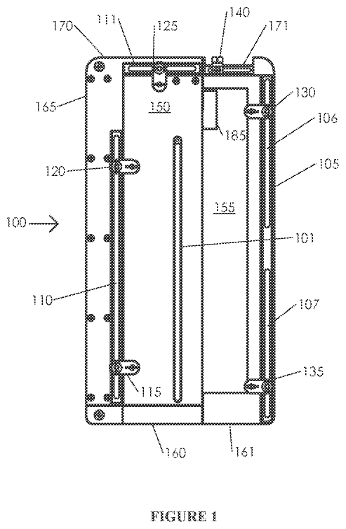

Preferred embodiments of the present invention and their advantages may be understood by referring to FIGS. 1-14, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an.” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 is an exemplary top view of a platform framer apparatus, according to an embodiment of the present inventions. As depicted, the platform framer 100 can include two longitudinal sides forming the framer; 105 and 165. Longitudinal side 105 can include a slide track 106 and 107 accommodating saw hold down clamps 130 and 135 used to attach the power circular saw base plate (not shown) to the platform framer 100. The saw hold down clamps 130 and 135 can move back and forth along slide tracks 106 and 107 to adjust attachment of a power circular saw (not shown) to platform framer 100. The framer sides 105 and 165 can be constructed using a U-shaped, solid, or partially solid construction of light metal, composite, polymer, plastic, and/or acrylic material or combinations thereof.

As depicted, longitudinal side 165 can consist of a longitudinal metal, composite, and/or acrylic/polymer/plastic structure that can extend the length of platform framer 100. A spring (not shown) can be integrated inside a housing in longitudinal side 165 in a dust-free enclosure to facilitate sliding the platform (only exposed sliding lower end 160 depicted). Alternatively, longitudinal side 105 can likewise incorporate a spring in a dust-free enclosure. Saw hold down clamp track 110 can integrate saw hold down clamps 115 and 120 that can be adjusted back and forth along saw hold down clamp track 110. Upper end 170 can include saw hold down clamp track 111 that accommodates saw hold down clamp 125 to move along saw hold down clamp track 111. Lower end 160 can comprise the exposed portion of a slide that moves back and forth below platform 150. Lower end 161 can help support an attached power circular saw as the platform 150 moves along the slide. Upper end 171 can move back and forth inside upper end 170 to adjust the width of platform framer 100.

As depicted, platform 150 can include center guide 101 that helps guide the platform 150 and the slide (not shown) as the platform 150 with attached power circular saw moves back and forth along the slide. A saw blade slot 155 can accommodate the saw blade when the power circular saw attaches to platform framer 100. Saw hold down clamps 115, 120, 125, 130, and 135 can secure power circular saw to the platform framer 100. Fence 185 can fold down to use to push up against an article of building material to hold the saw against the desired cut, and adjustable sight gage 140 can be used to accurately visually position the saw for the desired cut.

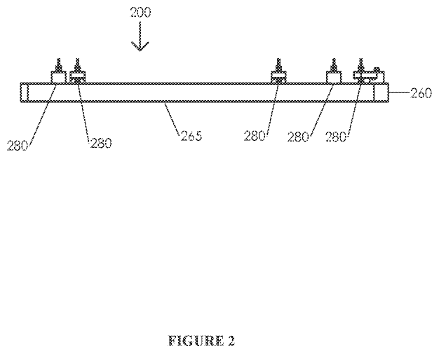

FIG. 2 is an exemplary side view of the long side 200 of platform framer of FIG. 1, according to an embodiment of the present inventions. As depicted, long side 200 can include longitudinal side 265 and shows five saw hold down clamps 280 corresponding to clamps 115, 120, 125, 130, and 135 of FIG. 1. The end of slide 260 can extend outward and move into and out of longitudinal side 265.

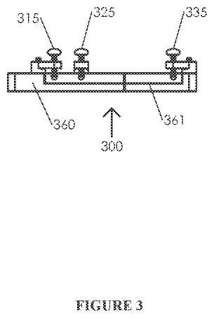

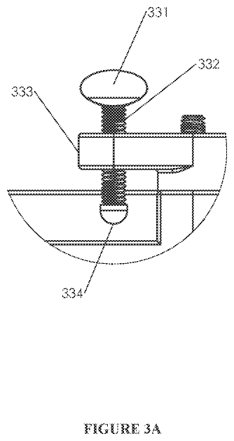

FIG. 3 is an exemplary side view of the lower end side 300 of platform framer of FIG. 1, according to an embodiment of the present inventions. As depicted, lower end side 300 can include lower end 360 and lower end 361. Lower end 360 can slide away from lower end 361 to adjust width of the platform framer. Lower end 360 can comprise a slide that platform can move on. Lower end 361 can help support an attached power circular saw as the platform moves along the slide. Hold down clamps 315, 325, and 335 are depicted extending upward from the platform.

FIG. 3A is an exemplary enlarged view of saw hold down clamp 335 shown in FIG. 3, according to an embodiment of the present inventions. Hold down clamp 335 can include a screw head 331, which can comprise a thumb screw head, conventional screw head, a knurled head, or a hexagonal screw head, or a Phillips head. Screwed shank 332 can be inserted into a nut structure 333 fixed to the platform framer. The distal end of screw shank 332 comprises a rubber or other gripping material 334 to better hold and secure a saw baseplate to the platform framer.

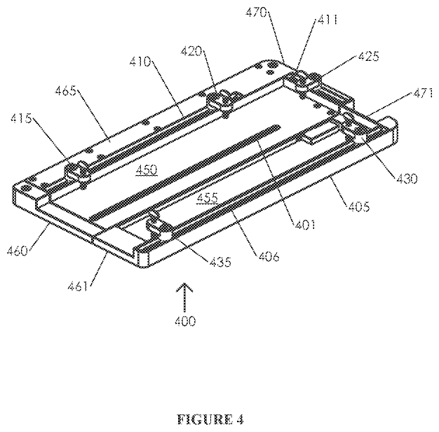

FIG. 4 is an exemplary perspective top view 400 of a platform framer apparatus, according to an embodiment of the present inventions. As depicted, the platform framer 400 can include two longitudinal sides; 405 and 465. Longitudinal side 405 can accommodate saw hold down clamps 430 and 435 used to attach the power circular saw base plate (not shown) to the platform framer 400. The saw hold down clamps 430 and 435 can move back and forth along slide track 406 to adjust attachment of a power circular saw (not shown) to platform framer 400.

As depicted, longitudinal side 465 can consist of a longitudinal metal, composite, and/or acrylic/polymer/plastic structure that extends the length of platform framer 400. Saw hold down clamp track 410 can integrate saw hold down clamps 415 and 420 that can move back and forth. Upper end 470 can include saw hold down clamp track 411 that can accommodate saw hold down clamp 425. Lower end 460 can comprise the exposed portion of a slide that moves back and forth below platform 450. Lower end 461 can help support a circular power saw as it moves back and forth with platform 450. Upper end 471 can move back and forth inside upper end 470 to adjust the width of platform framer 400. As depicted, the platform framer 400 is in a full closed mode to accommodate the narrowest saw model saw base plate.

As depicted, platform 450 can include center guide 401 that helps guide the platform 450 and the slide as the platform 450 with attached power circular saw moves back and forth along the slide. A saw blade slot 455 can accommodate the saw blade when the power circular saw attaches to platform framer 400. Saw hold down clamps 415, 420, 425, 430, and 435 can secure power circular saw to the platform framer 400.

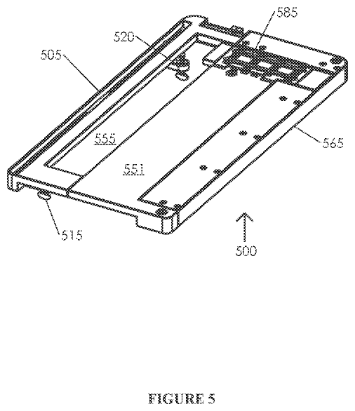

FIG. 5 is an exemplary perspective bottom view 500 of a platform framer apparatus, according to an embodiment of the present inventions. As depicted, the platform framer 500 can include two longitudinal sides; 505 and 565. Saw hold down clamps 515 and 520 can secure power circular saw to the platform framer 500. Slide 551 can be slid back and forth to allow platform 150 and 450 to move. A saw blade slot 555 can accommodate the saw blade when the power circular saw attaches to platform framer 500. Fence 585 can fold down to use to push up against an article of building material to hold the saw against the desired cut, as depicted in FIG. 5, the fence 585 is in the up, or closed, position.

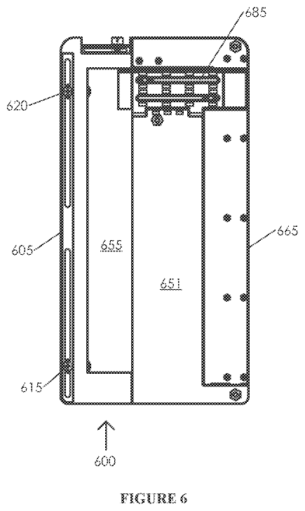

FIG. 6 is an exemplary bottom view 600 of a platform framer apparatus, according to an embodiment of the present inventions. As depicted, the platform framer 600 can include two longitudinal sides; 605 and 665. Saw hold down clamps 615 and 620 can secure power circular saw to the platform framer 600. Slide 651 can be slid back and forth and allow platform 150 and 450 to move with a power circular saw attached. A saw blade slot 655 can accommodate the saw blade when the power circular saw attaches to platform framer 600. Fence 685 can fold down in an open configuration to use to push up against an article of building material to hold the saw against the desired cut.

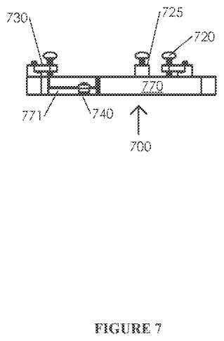

FIG. 7 is an exemplary side view of the upper end 700 of the platform framer of FIG. 1, according to an embodiment of the present inventions. As depicted, upper end side 700 can include fixed upper end 770 and upper end 771. Upper end 771 can slide in and out from upper end 770 to adjust width of the platform framer. Hold down clamps 720, 725, and 730 are depicted extending upward from the platform. Adjustable sight gage 740 can be used to guide the attached saw blade.

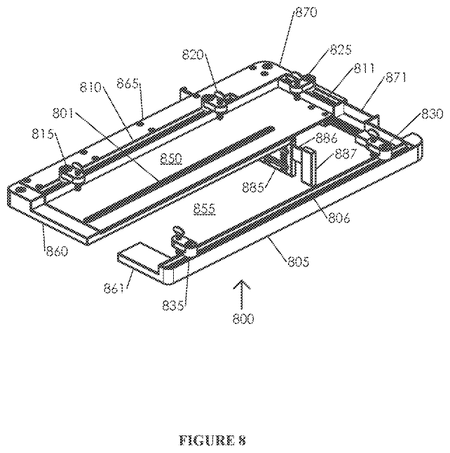

FIG. 8 is another exemplary perspective top view of the platform framer 800, according to an embodiment of the present inventions. As depicted, the platform framer 800 can include two longitudinal sides; 805 and 865. Longitudinal side 805 can accommodate saw hold down clamps 830 and 835 and can be used to attach the power circular saw base plate (not shown) to the platform framer 800. As shown, the saw hold down clamps 830 and 835 can move back and forth along slide track 806 to adjust attachment of a power circular saw (not shown) to platform framer 800.

As depicted, longitudinal side 865 can consist of a longitudinal metal, composite, or acrylic/plastic structure that extends the length of platform framer 800. Saw hold down clamp track 810 can integrate saw hold down clamps 815 and 820 that can be moved back and forth. Upper end 870 can include saw hold down clamp track 811 that accommodates saw hold down clamp 825. Lower end 861 can support the saw base plate of a power circular saw as the platform 850 moves back and forth on the slide. Upper end 871 can move back and forth inside upper end 870 to adjust the width of platform framer 800. As depicted, the platform framer 800 is in a full open mode to accommodate the widest saw model saw base plate.

As depicted, platform 850 can include center guide 801 that helps guide the platform 850 and the slide as the platform 850 with attached power circular saw moves back and forth along the slide. A saw blade slot 855 can accommodate the saw blade when the power circular saw attaches to platform framer 800. Saw hold down clamps 815, 820, 825, 830, and 835 can secure power circular saw to the platform framer 400. As shown, fence 885 can be folded down and extended out using extension arm 886 and vertical foot 887.

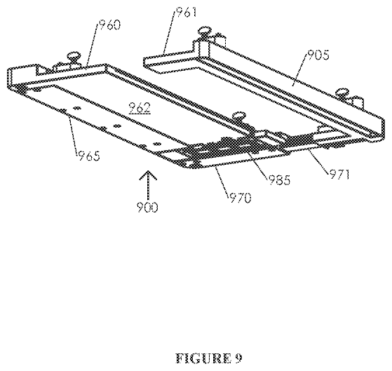

FIG. 9 is an exemplary perspective bottom view of the platform framer 900, according to an embodiment of the present inventions. As depicted, the platform framer 900 can include two longitudinal sides; 905 and 965. Longitudinal side 965 can consist of a longitudinal metal, composite, or acrylic/plastic structure that extends the length of platform framer 900. Lower end 960 can comprise the slide 962 that moves back and forth below platform 850, and lower end 961 can support a power circular saw base plate as it moves back and forth on the slide 962. Upper end 971 can move back and forth inside upper end 970 to adjust the width of platform framer 900. As depicted, the platform framer 900 is in a full open mode to accommodate the widest saw model saw base plate. As shown, fence 985 can be folded up in a closed configuration.

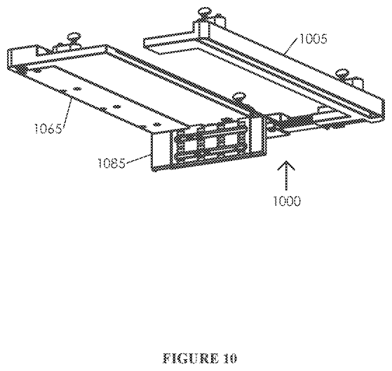

FIG. 10 is another exemplary perspective bottom view of the platform framer of FIG. 9, according to an embodiment of the present inventions. As depicted, the platform framer 1000 can include two longitudinal sides; 1005 and 1065. Longitudinal side 1065 can consist of a longitudinal metal, composite, and/or acrylic/polymer/plastic structure that extends the length of platform framer 1000. As depicted, fence 1085 can fold down to press up against an article being cut, and is in an open configuration.

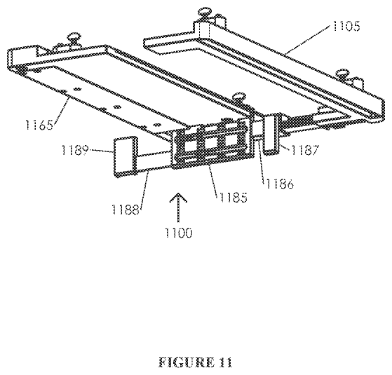

FIG. 11 is another exemplary perspective bottom view of the platform framer of FIG. 9, according to an embodiment of the present inventions. As depicted, the platform framer 1100 can include two longitudinal sides; 1105 and 1165. Longitudinal side 1165 can consist of a longitudinal metal, composite, and/or acrylic/polymer/plastic structure that extends the length of platform framer 1100. As depicted, fence 1185 can be folded down to press up against an article being cut, and is in an open configuration as depicted. Fence 1185 can be folded down and extended out using extension arm 1186 and vertical foot 1187 and extension arm 1188 and vertical foot 1189. The blade side of fence 1185 can be extended and secured in a position determined by the model of the power circular saw model. The guide hand side of fence 1185 can be extended as required for use by the guide hand thumb to press fence 1185 against an article being cut.

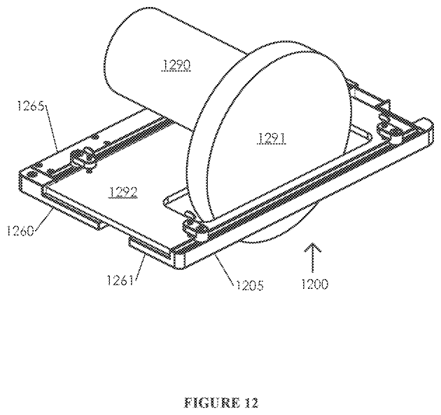

FIG. 12 is an exemplary perspective top view of the platform framer 1200 with a stylized power circular saw attached, according to an embodiment of the present inventions. Saw base plate 1292 can include an electric power motor 1290 that powers the saw blade 1291. Saw base plate 1292 can be fastened down to longitudinal sides 1205 and 1265 and lower end 1261. Although not shown, the circular power saw can make 90° cuts or be adjusted to make angled cuts using saw base plate 1292, which typically can be adjusted from 90° to about 45°, or more, cutting angles.

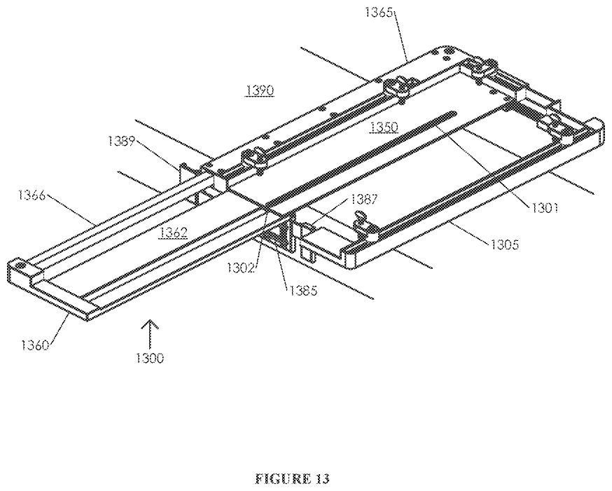

FIG. 13 is an exemplary perspective top view of the platform framer 1300 with slide 1362 extended and the fence 1385 lowered and the platform framer 1300 fully opened, according to an embodiment of the present inventions. As depicted, platform 1350 can incorporate a center guide slot 1301 that fits onto slide 1362. The post screw 1302 can be attached to slide 1362 and slides/moves within guide slot 1301. End 1360 can comprise the end of slide 1362. Platform 1350 can move back and forth on top of slide 1362. The platform 1350 can include longitudinal sides 1365 and 1305. The fence 1385 can be folded down with vertical foots 1387 and 1389 extended. Fence 1385 and vertical foots 1387 and 1389 can press against article 1390. Housing 1366 can comprise a spring sealed in a dust-free environment that can facilitate moving platform 1350 along slide 1362. This housing 1366 with the spring can be incorporated as a structural part of either platform 1350 or slide 1362, depending on the actual configuration of the platform framer 1300. The housing 1366 and spring can be attached to slide 1362 at end 1360 end and/or at the lower end of side 1365.

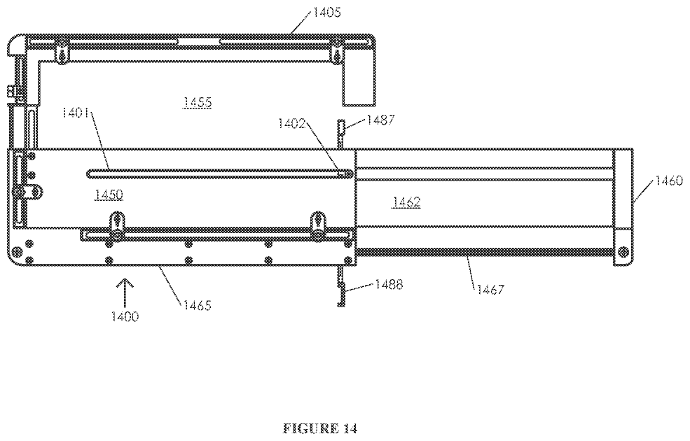

FIG. 14 is an exemplary top view of the platform framer 1400, according to an embodiment of the present inventions. As depicted, platform 1400 is fully opened and extended with slide 1462 extended and the fence (as reflected by vertical foots 1487 and 1488) lowered into position with the platform framer 1400 fully opened. Platform 1450 can incorporate a center guide 1401 that can be formed as a slot in the platform 1450, parallel to longitudinal sides 1405 and 1465, and a post screw 1402 protruding from slide 1462 through the aforementioned slot, as depicted. Alternatively, center guide 1401 can consist of mated stamped, machined, or molded depressions in platform 1450 and slide 1462. Platform 1450 can comprise longitudinal side 1465, with longitudinal side 1405 positioned opposite from side 1465. Saw blade slot 1455 can accommodate a circular power saw blade when attached. Vertical foots 1487 and 1488 can extend outward from fence 1385. Housing 1366 can further comprise a spring 1467 located in a dust-free enclosure to facilitate sliding the platform 1450. As depicted, slide 1462 can include end 1460, and housing 1466, and can incorporate the spring attached to slide 1462 at end 1460 and/or at the lower end of side 1465.

Insofar as the description above and the accompanying drawing disclose any additional subject matter that is not within the scope of the single claim below, the inventions are not dedicated to the public and the right to the one or more applications to claim such additional inventions is reserved.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The foregoing has described methods and systems for a patient movement monitoring and feedback system that are given for illustration and not for limitation and uses. Thus, the inventions are limited only by the appended claims. Although the inventions have been described in accordance with the embodiments shown, one of ordinary skill in the art will readily recognize that there could be variations to the embodiments and those variations would be within the spirit and scope of the present inventions. Accordingly, many modifications may be made by one of ordinary skill in the art without departing from the spirit and scope of the appended claims.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventors may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventors. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventors contemplate the various aspects in any number of claim forms. Accordingly, the inventors reserve the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Circular saws are manufactured in both right blade and left blade versions. The designs are identical except everything is reversed.

The saw platform design allows circular saw blade to be tilted up to 45°.

This invention can be used when cutting wood, synthetics (vinyl, urethane, PVC, composites, polymer etc.), thin metals (including metal studs which are popular in commercial construction) and composites.

The invention can be an accessory/attachment to an existing circular saw or integrated into a circular saw at original manufacturing. The saw can further be integrated into the design so as to be permanently attached.

The platform can adjust left-right to fit any width saw baseplate. The back end is open to accept any length saw baseplate. In a preferred embodiment, this device can specifically be designed to accommodate a 7¼″ circular saw blade diameter; the most common in the industry. However, the invention can be used on any standard circular saw having different blade diameters, with the understanding that depth of the cut will vary.

The device can also be one-piece, without left-right adjustment, sized to fit specific saw baseplates.

The device can be adapted and configured for use to cut other materials, such as synthetic wood substitutes to include fiber cement wood substitutes (e.g., Hardi Plank), engineered wood, or vinyl.

The device can be made with a mirrored configuration so the platform sides are reversed from the depicted configuration.

The back end as shown is open, allowing any saw base plate length to be used, but this two may be manufactured with a fixed length sized for specific saw base plates.

The platform can also be a fixed size versus a size adjustable design.

The design can be adapted for other cutting applications, such as into concrete, brick, or other masonry and flooring or paving materials.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

I claim:

1. A platform apparatus for cutting across an article of building material, comprising:
a platform supporting a power circular saw, with said platform adjustable for width;
the platform fitted onto a stationary slide to slide back and forth on;
the slide fitted with a folding fence to fold down and push against the building material;
a saw blade slot in the platform through which a power circular saw blade extends; and
wherein the platform together with the stationary slide positions the power circular saw blade to saw through the building material.

2. The platform apparatus of claim 1, further comprising:
multiple retention fasteners to fasten a saw base plate of the power circular saw to the platform.

3. The platform apparatus of claim 3, wherein the retention fasteners comprise hold down clamps comprising thumb screws and a gripping material in contact with a saw base plate of the power circular saw.

4. The platform apparatus of claim 1, further comprising:
a center guide to aid guiding of the platform over the slide.

5. The platform apparatus of claim 1, wherein the platform comprises an outer side incorporates a spring located in a dust-free enclosure to facilitate sliding of the platform over the slide.

6. The platform apparatus of claim 1, wherein the slide comprises an outer side incorporating a spring located in a dust-free enclosure to facilitate sliding of the platform over the slide.

7. The platform apparatus of claim 1, further comprising:
a fence attached to slide that folds down to press against the building material.

8. The platform apparatus of claim 7, wherein the fence can be extended into an open versus a closed configuration.

9. A cutting support device for a power circular saw, comprising:
a fixed stationary slide that can fit against an article of building material comprised of a folding fence that folds downward to press against the article of building material and facilitate accurately positioning a power circular saw to make a desired cut;
a sliding platform configured to receive and secure a power circular saw onto the platform;
said sliding platform fitting on top of and mated to the stationary slide and configured to slide back and forth along the stationary slide and across the article; and
the sliding platform including a saw blade slot for the power circular saw blade to extend through and an adjustable sight gage to accurately visually position the power circular saw for the desired cut.

10. The cutting support device of claim 9, further comprising:
multiple movable hold down clamps integrated into the sliding platform comprised of thumb screws and a gripping material in contact with a saw base plate of the power circular saw.

11. The cutting support device of claim 9, further comprising:
a center guide to aid guiding of the sliding platform over the fixed stationary slide.

12. The cutting support device of claim 9, wherein the sliding platform comprises an outer side formed with a housing that includes a spring located in a dust-free enclosure to facilitate moving the sliding platform over the fixed stationary slide.

13. The cutting support of claim 9, wherein the sliding platform comprises an outer side incorporating a spring located in a dust-free enclosure to facilitate moving the sliding platform over the fixed stationary slide.

14. A method for cutting an article of building material, comprising:
supporting a power circular saw using a sliding platform, with said sliding platform adjustable for width;
fitting the sliding platform onto a stationary slide with the sliding platform configured to slide back and forth on the stationary slide;
incorporating a folding fence into the sliding platform that can be folded down to push against the building material;
providing a saw blade slot in the sliding platform through which a power circular saw blade extends; and
wherein the sliding platform together with the stationary slide positions the power circular saw blade to saw through the article of building material.

15. The method for cutting an article of building material of claim 14, further comprising:
multiple retention fasteners to fasten a saw base plate of the power circular saw onto the sliding platform.

16. The method for cutting an article of building material of claim 15, wherein the retention fasteners comprise hold down clamps comprising thumb screws and a gripping material in contact with the saw base plate.

17. The method for cutting an article of building material of claim 14, wherein the sliding platform comprises a center guide to aid guiding of the sliding platform over the stationary slide.

18. The method for cutting an article of building material of claim 14, wherein the sliding platform comprises an outer side that includes a spring located in a dust free enclosure to facilitate sliding of the sliding platform over the stationary slide.

19. The method for cutting an article of building material of claim 14, wherein the slide comprises an outer side incorporating a spring located in a dust-free enclosure to facilitate sliding of the platform over the slide.

20. The method for cutting an article of building material of claim 14, wherein the folding fence further comprises at least one extension to adjust the width of the fence.
